(19) United States
(12) Patent Application Publication
(10) Pub. No.: US 2015/0187311 A1
(43) Pub. Date: Jul. 2, 2015

(54) SCAN DRIVING CIRCUIT OF LCD PANEL, THE LCD PANEL, AND METHOD FOR DRIVING THE SCAN DRIVING CIRCUIT OF THE LCD PANEL

(71) Applicant: SHENZHEN CHINA STAR OPTOELECTRONICS TECHNOLOGY CO. LTD., Shenzhen (CN)

(72) Inventor: Ping-sheng Kuo, Shenzhen (CN)

(21) Appl. No.: 14/346,725

(22) PCT Filed: Jan. 27, 2014
(86) PCT No.: PCT/CN2014/071537

§ 371 Date: Mar. 23, 2014

(30) Foreign Application Priority Data
Dec. 31, 2013 (CN) 201310753794.4

(51) Int. Cl. G09G 3/36; G02F 1/133; G09G 5/18; G02F 1/1368

(52) U.S. Cl. CPC G09G 3/3674; G02F 1/1368; G02F 1/13306; G09G 5/18

(57) ABSTRACT

The present disclosure provides a scan driving circuit of a liquid crystal display (LCD) panel, the LCD panel, and a driving method of the LCD panel. The scan driving circuit of the LCD panel includes a plurality of driving assemblies that are successively cascaded. Each of the driving assemblies includes a first driving unit, a second driving unit, and a first controllable switch. The first driving unit includes a first pull-up control unit, a first pull-up switch, a first pull-down control unit, and a first pull-down switch. A pre-charge signal is input to an input end of the first pull-up control unit, a reference low level signal is input to an output end of the first pull-up control unit via the first pull-down control unit, and the output end of the first pull-up control unit is also coupled to a control end of the first pull-up switch. A first scanning clock signal is input to an input end of the first pull-up switch. The reference low level signal is input to an output end of the first pull-up switch via the first pull-down switch. A storage capacitor is connected between a control end and the output end of the first pull-up switch. The second driving unit saves the area of the pull-up control unit and the storage capacitor as compared to the first driving unit.

### TECHNICAL FIELD

The present disclosure relates to the field of liquid crystal display (LCD), and more particularly to a scan driving circuit of an LCD panel, the LCD panel, and a method for driving the scan driving circuit of the LCD panel.

### BACKGROUND

A liquid crystal display (LCD) panel includes scan lines and a scan driving circuit, where a typical scan driving circuit includes shift registers corresponding to the scan lines one to one, where the shift registers are cascaded. Since each of the shift registers occupies a large area, especially when scan driver chips are integrated on a glass substrate, namely a gate driver on array (GOA) method. The GOA method is widely applied to electrical devices with LCD panels, such as smart phones, flat panel computers, and televisions. Since the GOA method is achieved by etching and disposing circuits of the shift register on the LCD panels, effect of the area of the scan driving circuits relative to a width of frames of the LCD panels is more distinct.

### SUMMARY

In view of the above-described problems, the aim of the present disclosure is to provide a scan driving circuit of a liquid crystal display (LCD) panel, the LCD panel, and the a method for driving the scan driving circuit of the LCD panel capable of decreasing space of the driving circuit.

The aim of the present disclosure is achieved by the following technical scheme.

A scan driving circuit of a liquid crystal display (LCD) panel includes a plurality of driving assemblies that are successively cascaded. Each of the driving assemblies comprises a first driving unit, a second driving unit, and a first controllable switch. The first driving unit comprises a first pull-up control unit, a first pull-up switch, a first pull-down control unit, and a first pull-down switch. A pre-charge signal is input to an input end of the first pull-up control unit, a reference low level signal is input to an output end of the first pull-up control unit via the first pull-down control unit, and the output end of the first pull-up control unit is also coupled to a control end of the first pull-up switch. A first scanning clock signal is input to an input end of the first pull-up switch. The reference low level signal is input to an output end of the first pull-up switch via the first pull-down switch. A storage capacitor is connected between a control end and the output end of the first pull-up switch.

The second driving unit comprises a second pull-up switch, a second pull-down control unit, and a second pull-down switch. A second scanning clock signal is input to an input end of the second pull-up switch, and the reference low level signal is input to an output end of the second pull-up switch via the second pull-down switch. The reference low level signal is input to a control end of the second pull-up switch via the second pull-down control unit, and the control end of the second pull-up switch is coupled to the control end of the first pull-up switch via the first controllable switch.

Furthermore, the first pull-up control unit comprises a second controllable switch, and the first pull-up switch comprises a third controllable switch, and the second pull-up switch comprises a four controllable switch. A control end of the third controllable switch is coupled to an output end of the second controllable switch and an output end of the third controllable switch is coupled to a first scan line of three adjacent scan lines of the LCD panel, and an output end of the fourth controllable switch is coupled to a second scan line of three adjacent scan lines of the LCD panel.

Furthermore, an input end of the first controllable switch is directly and electrically connected with a control end of the first controllable switch. A fifth controllable switch is connected in series with a control end of the fourth controllable switch, and the reference low level signal is input to the fifth controllable switch. The fifth controllable switch turns off when the second controllable switch turns on. The second controllable switch pre-charges to the voltage of the output end Qn of the first pull-up control unit, and the second driving unit is pre-charged through the first controllable switch Q1, which may cause the fourth controllable switch to turn on, and the second scan clock signal outputs the high level to drive the second scan line. At the same time, the fifth controllable switch can reduce potential of the control end of the fourth controllable to avoid turning on the fourth controllable switch. It should be understood, the fourth controllable switch turns on to pre-charge to the second scan line, which does not affect the display of the LCD panel, because charging in advance is regarded as the pre-charge, and response speed of the LCD panel improves.

Furthermore, the second driving unit comprises a seventh controllable switch and a first capacitor that are connected in series, the second scanning clock signal is input to the first capacitor, and the reference low level signal is input to the seventh controllable switch. A control end of the fifth controllable switch is connected with an input end of the seventh controllable switch.

Furthermore, the second pull-down control unit comprises a sixth controllable switch, where a control end of the sixth controllable switch is coupled to a third scan line adjacent to the second scan line. The second pull-down switch comprises an eighth controllable switch and a ninth controllable switch, and a control end of the eighth controllable switch is coupled to the third scan line. A control end of the ninth controllable switch is coupled to an input end of the seventh controllable switch.

Furthermore, an input end of the second controllable switch is directly and electrically connected with a control end of the second controllable switch.

Furthermore, a tenth controllable switch is connected in series with the control end of the third controllable switch, and the reference low level signal is input to the tenth controllable switch. The tenth controllable switch turns off when the second controllable switch turns on. The first pull-up control unit comprises an eleventh controllable switch, and a control end of the eleventh controllable switch is coupled to the second scan line.

The first driving unit further comprises a twelfth controllable switch and a second capacitor that are connected in series. The first scanning clock signal is input to the second capacitor, and the reference low level signal is input to the twelfth controllable switch. A control end of the tenth controllable switch is connected with an input end of the twelfth controllable switch. The first pull-down switch comprises a thirteenth controllable switch and a fourteenth controllable switch, and the thirteenth controllable switch is connected in parallel with the fourteenth controllable. A control end of the thirteenth controllable switch is coupled to the second scan line. A control end of the fourteenth controllable switch is coupled to an input end of the twelfth controllable switch.

A liquid crystal display (LCD) panel comprises an array substrate and a scan driving circuit. The first driving unit and the second driving unit are arranged on the array substrate of the LCD panel.

A method for driving the scan driving circuit of the LCD panel comprises:
outputting for a preset reference time, and controlling a first controllable switch to turn on in the preset reference time of outputting the pre-charge signal of the second driving unit; and
turning off the pre-charge signal, and outputting a high level signal by a first scan clock signal

Furthermore, turning off a second pull-up switch in the preset reference time of outputting the pre-charge signal of the second driving unit, controlling the second pull-up switch to turn on after turning off the first controllable switch, and outputting a first scanning clock signal.

For the typical scan driving circuit, especially to circuit of the GOA, since two driving circuit of the GOA circuit are same. Each of the scan lines correspond to the driving unit one by one, which occupies great area. This present disclosure provides the first controllable switch, and driving outputs of the first driving unit is coupled to the second driving unit, thus, a circuit for pre-charge does not need be arranged (such as the first pull-up control unit of the first driving unit cannot be applied to the second driving unit). And the storage capacitor C does not need be arranged between the control end and the output end of the second pull-up switch. FIG. 1 is a schematic diagram of circuit area of the scan driving circuit of a 32-inch LCD panel. The storage capacitor C occupies more than one-sixth of area of the scan driving circuit of the GOA. Thus, one storage capacitor is not used, which obviously reduces space of the GOA. Thus, the space of the scan driving circuit does not increase when driving capability of the circuit improves and color wash-out is reduced because driving capability of the scan driving circuit increases, which allows for narrower frames.

### BRIEF DESCRIPTION OF FIGURES

FIG. 1 is a schematic diagram of arrangement of area of a scan driving circuit of a 32-inch of a liquid crystal display (LCD) panel.

FIG. 2 is a schematic diagram of an LCD panel of a gat driver on array (GOA).

FIG. 3 is a structural diagram of a scan driving circuit of an LCD panel.

FIG. 4 is a schematic diagram of a scan driving circuit of an LCD panel of an example of the present disclosure.

FIG. 5 is a flowchart of a method for driving a scan driving circuit of an LCD panel of an example of the present disclosure.

FIG. 6 is a schematic diagram of a control sequence of a scan driving circuit of an LCD panel of an example of the present disclosure.

### DETAILED DESCRIPTION

As shown in FIG. 2 and FIG. 3, the present disclosure provides a liquid crystal display (LCD) panel and a scan driving circuit of the LCD panel, where the LCD panel comprises an array substrate 1 and a scan driving circuit 2. The scan driving circuit 2 comprises a plurality of driving assemblies 3 that are successively cascaded. Each of the driving assemblies 3 comprises a first driving unit 10, a second driving unit 20, and a first controllable switch Q1. The array substrate comprises a plurality of scan lines 4. The first driving unit 10 and the second driving unit 20 are arranged on the array substrate of the LCD panel. For a two-sides driving LCD panel, the driving assemblies are respectively located on two sides of the LCD panel, and two ends of the scan lines are driven at a same time.

The first driving unit 10 comprises a first pull-up control unit 11, a first pull-up switch 12, a first pull-down control unit 13, and a first pull-down switch 14. A pre-charge signal STV is input to an input end of the first pull-up control unit 11, a reference low level signal VSS (logic 0) is input to an output end of the first pull-up control unit via the first pull-down control unit 13 and the output end of the first pull-up control unit is also coupled to a control end of the first pull-up switch 12. A first scanning clock signal CK is input to an input end of the first pull-up switch 12. The reference low level signal is input to an output end of the first pull-up switch 12 via the first pull-down switch 14. A storage capacitor C is connected between a control end and the output end of the first pull-up switch 12.

The second driving unit comprises a second pull-up switch 21, a second pull-down control unit 22, and a second pull-down switch 23, where a second scanning clock signal XCK is input to an input end of the second pull-up switch 21 via the second pull-down control unit 22. The reference low level signal VSS is input to an output end of the second pull-up switch 21 via the second pull-down switch 23. The reference low level signal VSS is input to a control end of the second pull-up switch 21 via the second pull-down control unit 22, and the control end of the second pull-up switch 21 is coupled to the control end of the first pull-up switch 12 via the first controllable switch.

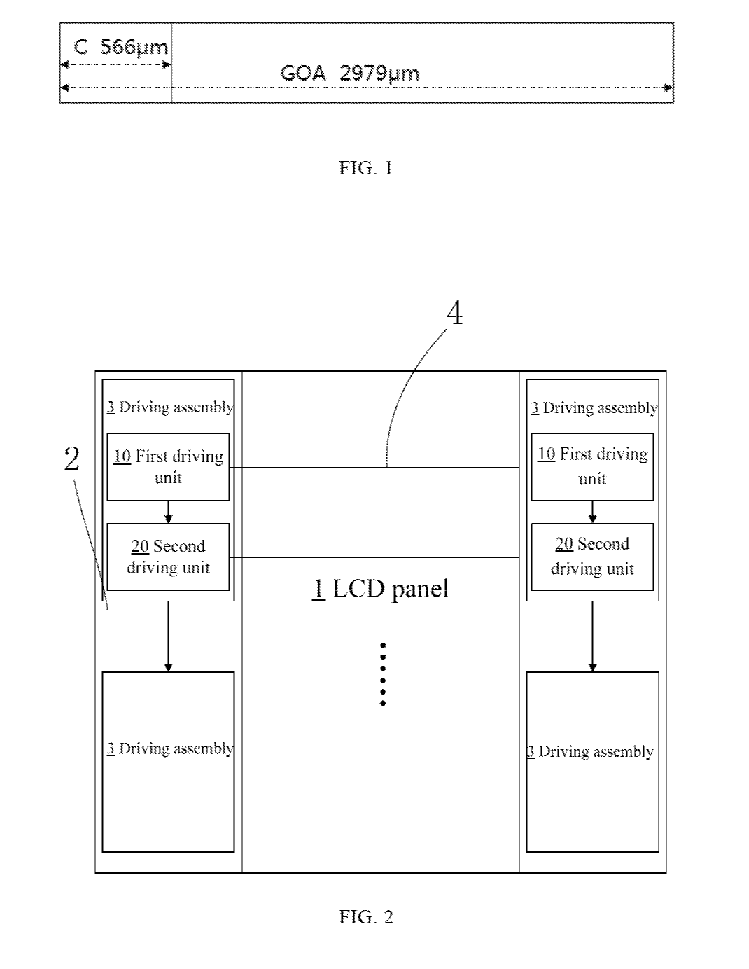

If an extra driving circuit is added in the GOA, and since two driving circuit are same, the arranging area of the driving circuits is two times the arranging area of a single driving circuit. This present disclosure provides the first controllable switch, and driving outputs of the first driving unit is coupled to the second driving unit, thus, a circuit for pre-charge does not need be arranged (such as the first pull-up control unit of the first driving unit cannot be applied to the second driving unit). And the storage capacitor C does not need be arranged between the control end and the output end of the second pull-up switch. FIG. 1 is a schematic diagram of circuit area of the scan driving circuit of a 32-inch LCD panel. The storage capacitor C occupies more than one-sixth of area of the scan driving circuit of the GOA. Thus, one storage capacitor is not used, which obviously reduces space of the GOA. Thus, the space of the scan driving circuit does not increase when driving capability of the circuit improves and color wash-out is reduced because driving capability of the scan driving circuit increases, which allows for narrower frames.

The present disclosure will further be described in detail in accordance with the figures and the exemplary examples.

### Example 1

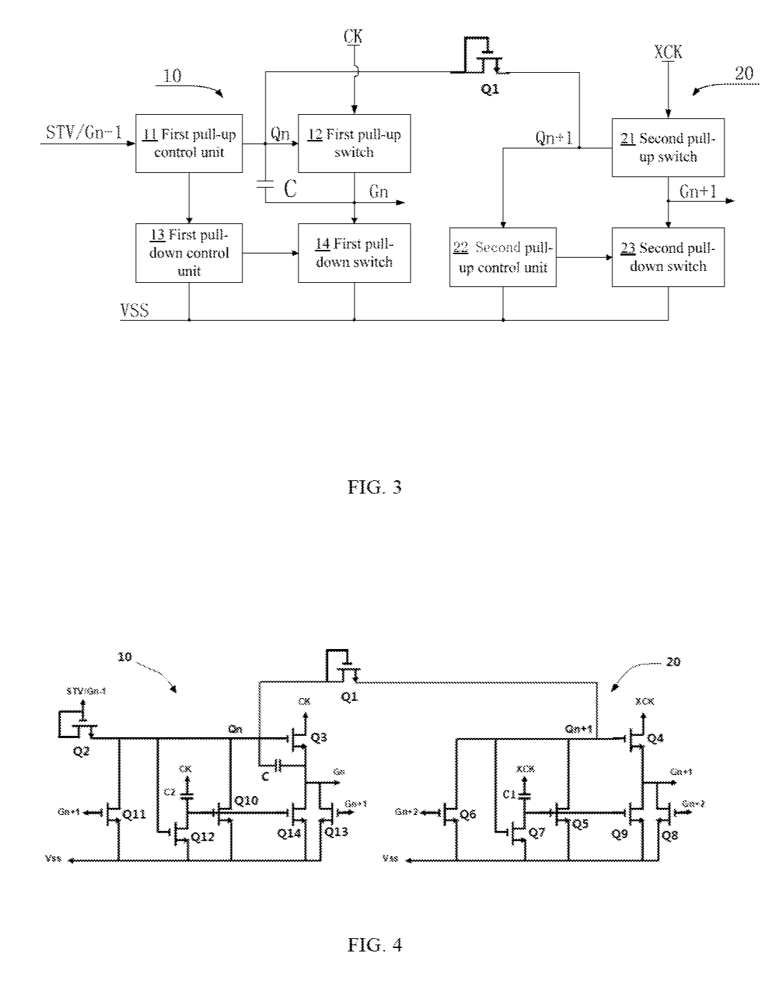

As shown in FIG. 4, a first example provides the first pull-up control unit comprising a second controllable switch. The first pull-up switch comprises a third controllable switch, and the second pull-up switch comprises a four controllable switch.

The scan driving circuit comprises the first driving unit 10, the second driving unit 20, and the first controllable switch Q1, where the first driving unit 10 comprises a second controllable switch Q2 and the storage capacitor. The pre-charge signal STV is input to an input end of the second controllable switch Q2, and an output end of the second controllable switch Q2 is coupled to a first scan line Gn of three adjacent scan lines via the storage capacitor C. The first driving unit 10 is coupled to the second driving unit 20 via the first controllable switch Q1. The input end of the second controllable switch Q2 is directly and electrically connected with a control end of the second controllable switch Q2. The first driving unit 10 and the second driving unit 20 are arranged on the array substrate of the LCD panel, and the LCD panel is driven by the first driving unit 10 and the second driving unit 20 from one end of the scan line.

A control end of the third controllable switch Q3 is coupled to the output end of the second controllable switch Q2, the first scanning clock signal CK is input to an input end of the third controllable switch Q3, and the first scanning clock signal CK is a rectangular waveform. An output end of the third controllable switch Q3 is coupled to the first scan line Gn of the three adjacent scan lines of the LCD panel.

The second driving unit comprises a fourth controllable switch Q4, where a control end of the fourth controllable switch Q4 is coupled to the input end of the first controllable switch Q1, the second scanning clock signal XCK is input to an input end of the fourth controllable switch Q4, and the second scanning clock signal XCK is the rectangular waveform. An output end of the fourth controllable switch Q4 is coupled to a second scan line Gn+1 adjacent to the first scan line Gn.

The input end of the first controllable switch Q1 is directly and electrically connected with a control end of the first controllable switch Q1. The second pull-down control unit comprises a fifth controllable switch Q5, where the fifth controllable switch Q5 is connected in series with the control end of the fourth controllable switch Q4, and the reference low level signal (logic 0) is input to the fifth controllable switch Q5. The fifth controllable switch Q5 turns off when the second controllable switch Q2 turns on.

A sixth controllable switch Q6 is connected in series with the control end of the fourth controllable switch Q4, and the reference low level signal is input to the sixth controllable switch Q6. A control end of the sixth controllable switch Q6 is coupled to a third scan line Gn+2 adjacent to the second scan line Gn+1.

The second driving unit comprises a seventh controllable switch Q7 and a first capacitor C1 that are connected in series, where the second scanning clock signal XCK is input to the first capacitor C1, and the reference low level signal VSS is input to the seventh controllable switch Q7. A control end of the fifth controllable switch Q5 is connected with an input end of the seventh controllable switch Q7.

The second pull-down switch comprises an eighth controllable switch Q8 and a ninth controllable switch Q9, where the eighth controllable switch Q8 is connected with the ninth controllable Q9 in parallel. The eighth controllable switch Q8 and the ninth controllable Q9 are connected in series with the output end of the fourth controllable switch Q4, and the reference low level signal VSS is input to the eighth controllable switch Q8 and the ninth controllable Q9. A control end of the eight controllable switch Q8 is coupled to the third scan line Gn+2. A control end of the ninth controllable switch Q9 is coupled to an input end of the seventh controllable switch Q7.

A tenth controllable switch Q0 is connected in series with the control end of the third controllable switch Q3, and the reference low level signal VSS is input to the tenth controllable switch Q10. The tenth controllable switch Q10 turns off when the second controllable switch Q2 turns on.

The first pull-down control unit comprises an eleventh controllable switch Q11, where the eleventh controllable switch Q11 is connected in series with the control end of the third controllable switch Q3, and the reference low level signal VSS is input to the eleventh controllable switch Q1. A control end of the eleventh controllable switch Q11 is coupled to the second scan line Gn+1.

The first driving unit further comprises a twelfth controllable switch Q12 and a second capacitor C2 that are connected in series, where the first scanning clock signal CK is input to the second capacitor C2, and the reference low level signal is input to the twelfth controllable switch Q12. A control end of the tenth controllable switch Q10 is connected with an input end of the twelfth controllable switch Q12.

The first pull-down switch comprises a thirteenth controllable switch Q13 and a fourteenth controllable switch Q14, where the thirteenth controllable switch Q13 is connected with the fourteenth controllable Q14 in parallel. The thirteenth controllable switch Q13 and the fourteenth controllable Q14 are connected in series with the output end of the third controllable switch Q3, and the reference low level signal VSS is input to the thirteenth controllable switch Q13 and the fourteenth controllable Q14. A control end of the thirteenth controllable switch Q13 is coupled to the second scan line Gn+1. A control end of the fourteenth controllable switch Q14 is coupled to an input end of the twelfth controllable switch Q12.

### Example 2

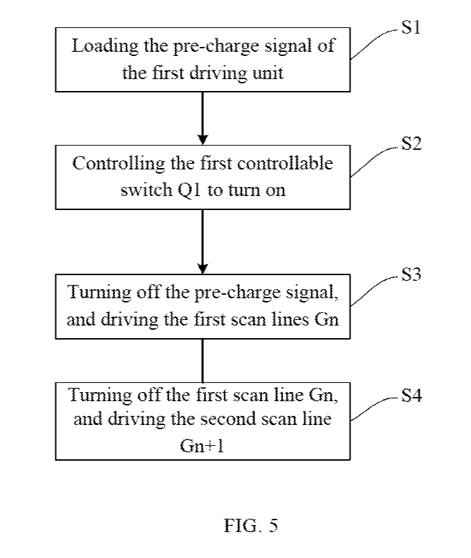

As shown in FIG. 3. FIG. 4, and FIG. 5, a second example provides a method for driving the scan driving circuit of the LCD panel of the present disclosure, the method comprises:

S1: loading the pre-charge signal of the first driving unit, and outputting a pre-charge signal of the second driving unit through the first pull-up control unit for a preset reference time:

S2: controlling the first controllable switch Q1 to turn on in the preset reference time of outputting the pre-charge signal of the second driving unit,

S3: turning off the pre-charge signal, and outputting the high level signal by the first scan clock signal to drive the first scan lines Gn; and

S4: outputting the low level signal by the first scanning clock signal after the preset reference time of outputting the pre-charge signal of the second driving unit, at a same time, and outputting the high level signal by the second scanning clock signal to drive the second scan line Gn+1.

If the driving assembly is the first driving assembly, and the pre-charge signal of the first driving unit is an initial trigger signal STV. For other driving assemblies, the pre-charge signal of the first driving unit is a driving signal of a previous scan line.

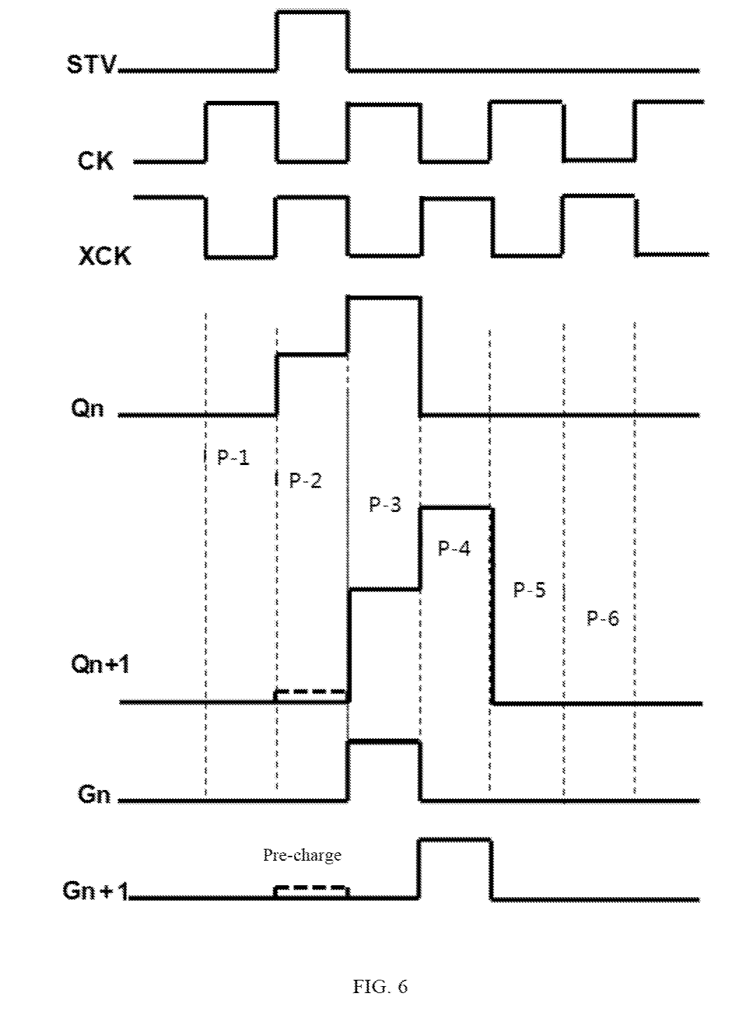

The second example refers to the scan driving circuit of FIG. 4, and driving sequence of the scan driving circuit is shown in FIG. 6. At P-2 stage, the second controllable switch pre-charges to an output end Qn of the first pull-up control unit, and a voltage of the output end Qn of the first pull-up control unit is divided by the first controllable switch Q1, thus, a voltage of an control end Qn+1 of the second pull-up switch is less than the voltage of the output end Qn of the first pull-up control unit. The second pull-up switch incompletely turns on to pre-charge to the second scan line Gn+1. At p-3 stage, the voltage of the output end Qn of the first pull-up control unit boosts up via the first scan line Gn and the storage capacitor C, at the same time, the voltage of the control end Qn+1 of the second pull-up switch completely reaches a voltage of turning-on of the second pull-up switch.

At p-4 stage, the second scan clock signal XCK is a high level (logic 1), and drives the second scan line Gn+1. The voltage of the control end Qn+1 of the second pull-up switch further increases because of adding extra voltages of the second pull-up switch to improve driving capability of the second scan line Gn+1, which reduces the color wash-out because of large size of the LCD panel. Thus, the GOA can be applied to high resolution production.

At the p-2 stage, the second controllable switch pre-charges to the voltage of the output end Qn of the first pull-up control unit, and the second driving unit is pre-charged through the first controllable switch QL, which may cause the fourth controllable switch to turn on, and the second scan clock signal outputs the high level to drive the second scan line. At the same time, the fifth controllable switch can reduce potential of Qn+1 to avoid turning on the fourth controllable switch. It should be understood, the fourth controllable switch turns on to pre-charge to the second scan line, which does not affect the display of the LCD panel, because charging in advance is regarded as the pre-charge, and response speed of the LCD panel improves.

As parasitic resistance and capacitance of the scan line are great, thin film transistor corresponding to the scan lines receives wrong data signal, which causes the color wash-out. For a two-sides of the GOA, distortion of a waveform in the middle position of the scan line is more obvious than other positions, and transfer direction of the GOA signal is from top to bottom, thus, waveform distortion of the scan line at a bottom of the LCD panel is greater than that of the scan line at a top of the LCD panel. Thus, the color wash-out is formed at a middle-lower position.

This present disclosure provides the first controllable switch, and the driving outputs of the first driving unit is coupled to the second driving unit, thus, the circuit for pre-charge does not need be arranged (such as the first pull-up control unit of the first driving unit), and the storage capacitor C is omitted. As shown in FIG. 1, the storage capacitor C occupies more than one-sixth of area of the scan driving circuit of the GOA. Thus, one storage capacitor is not used, which obviously reduces space of the GOA. Thus, the space of the scan driving circuit does not increase when driving capability of the circuit improves and the color wash-out is reduced because driving capability of the scan driving circuit increases, which allows for narrower frames.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A scan driving circuit of a liquid crystal display (LCD) panel, comprising:
a plurality of driving assemblies that are successively cascaded; and
wherein each of the driving assemblies comprises a first driving unit, a second driving unit, and a first controllable switch: the first driving unit comprises a first pull-up control unit, a first pull-up switch, a first pull-down control unit, and a first pull-down switch; a pre-charge signal is input to an input end of the first pull-up control unit, a reference low level signal is input to an output end of the first pull-up control unit via the first pull-down control unit, and the output end of the first pull-up control unit is also coupled to a control end of the first pull-up switch; a first scanning clock signal is input to an input end of the first pull-up switch; the reference low level signal is input to an output end of the first pull-up switch via the first pull-down switch; a storage capacitor is connected between a control end and the output end of the first pull-up switch:
wherein the second driving unit comprises a second pull-up switch, a second pull-down control unit, and a second pull-down switch; a second scanning clock signal is input to an input end of the second pull-up switch, and the reference low level signal is input to an output end of the second pull-up switch via the second pull-down switch; the reference low level signal is input to a control end of the second pull-up switch via the second pull-down control unit, and the control end of the second pull-up switch is coupled to the control end of the first pull-up switch via the first controllable switch.

2. The scan driving circuit of the LCD panel of claim 1, wherein the first pull-up control unit comprises a second controllable switch, the first pull-up switch comprises a third controllable switch, and the second pull-up switch comprises a four controllable switch; a control end of the third controllable switch is coupled to an output end of the second controllable switch, and an output end of the third controllable switch is coupled to a first scan line of three adjacent scan lines of the LCD panel; an output end of the fourth controllable switch is coupled to a second scan line of three adjacent scan lines of the LCD panel.

3. The scan driving circuit of the LCD panel of claim 2, wherein an input end of the first controllable switch is directly and electrically connected with a control end of the first controllable switch; a fifth controllable switch is connected in series with a control end of the fourth controllable switch, and the reference low level signal is input to the fifth controllable switch; the fifth controllable switch turns off when the second controllable switch turns on.

4. The scan driving circuit of the LCD panel of claim 3, wherein the second driving unit comprises a seventh controllable switch and a first capacitor that are connected in series, the second scanning clock signal is input to the first capacitor, and the reference low level signal is input to the seventh controllable switch; a control end of the fifth controllable switch is connected with an input end of the seventh controllable switch.

5. The scan driving circuit of the LCD panel of claim 4, wherein the second pull-down control unit comprises a sixth controllable switch; a control end of the sixth controllable switch is coupled to a third scan line adjacent to the second scan line:
the second pull-down switch comprises an eighth controllable switch and a ninth controllable switch; a control end of the eight controllable switch is coupled to the third scan line: a control end of the ninth controllable switch is coupled to an input end of the seventh controllable switch.

6. The scan driving circuit of the LCD panel of claim 3, wherein an input end of the second controllable switch is directly and electrically connected with a control end of the second controllable switch.

7. The scan driving circuit of the LCD panel of claim 6, wherein a tenth controllable switch is connected in series with the control end of the third controllable switch, and the reference low level signal is input to the tenth controllable switch; the tenth controllable switch turns off when the second controllable switch turns on;
the first pull-up control unit comprises an eleventh controllable switch, a control end of the eleventh controllable switch is coupled to the second scan line;
the first driving unit further comprises a twelfth controllable switch and a second capacitor that are connected in series; the first scanning clock signal is input to the second capacitor, and the reference low level signal is input to the twelfth controllable switch; a control end of the tenth controllable switch is connected with an input end of the twelfth controllable switch;
the first pull-down switch comprises a thirteenth controllable switch and a fourteenth controllable switch, and the thirteenth controllable switch is connected in parallel with the fourteenth controllable; a control end of the thirteenth controllable switch is coupled to the second scan line; a control end of the fourteenth controllable switch is coupled to an input end of the twelfth controllable switch.

8. A liquid crystal display (LCD) panel, comprising:
an array substrate; and
a scan driving circuit comprising a plurality of driving assemblies;
wherein the plurality of driving assemblies are successively cascaded; each of the driving assemblies comprises a first driving unit, a second driving unit, and a first controllable switch: the first driving unit comprises a first pull-up control unit, a first pull-up switch, a first pull-down control unit, and a first pull-down switch; a pre-charge signal is input to an input end of the first pull-up control unit, a reference low level signal is input to an output end of the first pull-up control unit via the first pull-down control unit, and the output end of the first pull-up control unit is also coupled to a control end of the first pull-up switch; a first scanning clock signal is input to an input end of the first pull-up switch; the reference low level signal is input to an output end of the first pull-up switch via the first pull-down switch; a storage capacitor is connected between a control end and the output end of the first pull-up switch;
wherein the second driving unit comprises a second pull-up switch, a second pull-down control unit, and a second pull-down switch; a second scanning clock signal is input to an input end of the second pull-up switch, and the reference low level signal is input to an output end of the second pull-up switch via the second pull-down switch; the reference low level signal is input to a control end of the second pull-up switch via the second pull-down control unit, and the control end of the second pull-up switch is coupled to the control end of the first pull-up switch via the first controllable switch; the first driving unit and the second driving unit are arranged at the array substrate of the LCD panel.

9. The LCD panel of claim 8, wherein the first pull-up control unit comprises a second controllable switch, the first pull-up switch comprises a third controllable switch, and the second pull-up switch comprises a four controllable switch; a control end of the third controllable switch is coupled to an output end of the second controllable switch and an output end of the third controllable switch is coupled to a first scan line of three adjacent scan lines of the LCD panel; an output end of the fourth controllable switch is coupled to a second scan line of three adjacent scan lines of the LCD panel.

10. The LCD panel of claim 9, wherein an input end of the first controllable switch is directly and electrically connected with a control end of the first controllable switch; a fifth controllable switch is connected in series with a control end of the fourth controllable switch, and the reference low level signal is input to the fifth controllable switch; the fifth controllable switch turns off when the second controllable switch turns on.

11. The LCD panel of claim 10, wherein the second driving unit comprises a seventh controllable switch and a first capacitor that are connected in series, the second scanning clock signal is input to the first capacitor, and the reference low level signal is input to the seventh controllable switch; a control end of the fifth controllable switch is connected with an input end of the seventh controllable switch.

12. The LCD panel of claim 11, wherein the second pull-down control unit comprises a sixth controllable switch; a control end of the sixth controllable switch is coupled to a third scan line adjacent to the second scan line;
the second pull-down switch comprises an eighth controllable switch and a ninth controllable switch; a control end of the eight controllable switch is coupled to the third scan line; a control end of the ninth controllable switch is coupled to an input end of the seventh controllable switch.

13. The LCD panel of claim 10, wherein an input end of the second controllable switch is directly and electrically connected with a control end of the second controllable switch.

14. The LCD panel of claim 13, wherein a tenth controllable switch is connected in series with the control end of the third controllable switch, and the reference low level signal is input to the tenth controllable switch; the tenth controllable switch turns off when the second controllable switch turns on;
the first pull-up control unit comprises an eleventh controllable switch; a control end of the eleventh controllable switch is coupled to the second scan line;
the first driving unit further comprises a twelfth controllable switch and a second capacitor that are connected in series; the first scanning clock signal is input to the second capacitor, and the reference low level signal is input to the twelfth controllable switch; a control end of the tenth controllable switch is connected with an input end of the twelfth controllable switch;
the first pull-down switch comprises a thirteenth controllable switch and a fourteenth controllable switch, and the thirteenth controllable switch is connected in parallel with the fourteenth controllable; a control end of the thirteenth controllable switch is coupled to the second scan line; a control end of the fourteenth controllable switch is coupled to an input end of the twelfth controllable switch.

15. A method for driving a scan driving circuit of a liquid crystal display (LCD) panel, comprising:
outputting a pre-charge signal of a second driving unit through a first pull-up control unit for a preset reference time, and controlling a first controllable switch to turn on in the preset reference time of outputting the pre-charge signal of the second driving unit; and
turning off the pre-charge signal, and outputting a high level signal by a first scan clock signal.

16. The method for driving the scan driving circuit of the LCD panel of claim 15, wherein turning off a second pull-up switch in the preset reference time of outputting the pre-charge signal of the second driving unit, controlling the second pull-up switch to turn on after turning off the first controllable switch, and outputting a first scanning clock signal.
